(19) United States
(12) Patent Application Publication
(10) Pub. No.: US 2010/0032247 A1
(43) Pub. Date: Feb. 11, 2010

(54) STACKER CRANE

(76) Inventor: Hiroyuki Amada, Yokohama-shi (JP)

Correspondence Address: OSTROLENK FABER GERB & SOFFEN, 1180 AVENUE OF THE AMERICAS, NEW YORK, NY, 100368403, US

(21) Appl. No.: 12/443,251

(22) PCT Filed: Sep. 20, 2007
(86) PCT No.: PCT/JP2007/068268

§ 371 Date: Mar. 27, 2009

(30) Foreign Application Priority Data
Sep. 28, 2006 (JP) 2006-266039

(51) Int. Cl. B65G 1/06; B66F 9/07; B66B 11/02

(52) U.S. Cl. 187/401

(57) ABSTRACT

A stacker crane travels on a track provided along storage shelves arranged on numerous levels, and by causing a cage which receives goods to move vertically between a set of masts erected vertically, conveys goods between the various storage shelves; the cage comprises a main frame, on which the goods are placed, a pair of side frames, provided at each of the end portions of the main frame, suspended by a driving device via an elevator wire, and which are caused to be moved vertically in a state of contact with the masts, and, buffer member, which, among the pair of side frames connected to the main frame, is installed only between one of the side frames and the connection portion with the main frame. Stress acting on the cage arising from a change in the mast interval can be reduced, without interposing a buffer member between the cage and guide rollers.

### TECHNICAL FIELD

This invention relates to a stacker crane, and in particular relates to a stacker crane in which a cage, having a main frame and side frames installed at both ends of the main frame, moves vertically between a set of masts.

This application claims priority from Japanese Patent Application No. 2006-266039, filed with the Japanese Patent Office on Sep. 28, 2006, the contents of which are incorporated herein by reference.

### BACKGROUND ART

For example, in an automated warehouse in which goods are stored on a plurality of storage shelves arranged in parallel in the vertical and horizontal directions, a stacker crane is used to convey goods. This stacker crane travels on a track provided along the storage shelves for goods, and by using a driving device to raise and lower a cage suspended via an elevator wire, can transfer goods between arbitrary storage shelves.

The above-described cave moves vertically between a set of vertically erected masts, and is guided by the masts. An elevator wire is passed over sheaves installed on the vertex portions of the masts, and is connected to the cage via the sheave.

In such a stacker crane, forces arising from the weight of the cage and from the driving power of a driving device are transmitted via the elevator wire to the masts, and as a result there are cases in which the mast center portions bow to the inside (the cage side). When the center portions of the masts bow to the inside in this way, the interval between the masts changes along the vertical direction, and the interval between the center portions of the masts becomes narrower than the intervals between the masts above and below.

In a stacker crane of the prior art, the cage is designed for strength, and bowing of masts has been addressed by causing the cage to move vertically while causing the cage to press outward against mast portions at which the interval between masts has become narrowed.

However, when the cage presses and widens the mast interval, strong forces act on the cage, and so there are concerns that smooth vertical cage movement may not be possible, or that the cage may be damaged. That is, when the mast interval changes, stresses originating in the change in mast interval act on the cage.

In Patent Reference 1, a stacker crane is described in which guide rollers which have the masts as sliding surfaces are fixed to the cage, with a buffer member intervening. By means of such a stacker crane, the above-described stresses are reduced through action of the buffer members, and smooth vertical motion of the cage can be realized, while also preventing damage to the cage.

Patent Reference 1: Japanese Unexamined Patent Application, First Publication No. 2000-142917

However, because guide rollers are small members compared with the cage itself, when using the technology described in Patent Reference 1, there are such drawbacks as that the buffer members are small and have a complex construction. For these reasons, technology is desired which employs a different configuration to reduce the stresses acting on the cage due to changes in the interval between masts.

Further, spring-loaded guide rollers can only be incorporated in the narrow space enclosed between the masts and the cage side frames, so that when large stresses act, due to the above reason, it is difficult to employ springs with large spring constants.

Further, in application to clean rooms, it is necessary to cover the surroundings to the extent physically possible. However, if springs or other extra components other than the guide rollers are installed, then there are such drawbacks as the fact that the interval between the cage and masts is widened, the covers have a more complex structure, it becomes more difficult to block gaps, and in addition, because the space is enclosed between the masts and cage, installation and removal of covers and other maintenance tasks become more difficult.

### DISCLOSURE OF THE INVENTION

This invention was devised in light of the above-described problems, and has an object the reduction of stresses acting on the cage arising from changes in the interval between masts, without the interposing buffer members between the cage and guide rollers.

In order to attain the above object, a stacker crane of this invention travels on a track provided along storage shelves arranged on numerous levels, and by causing a cage which receives goods to move vertically between a set of masts erected vertically, goods are conveyed between the various storage shelves. The cage comprises a main frame, on which the goods are placed; a pair of side frames, provided at each of the end portions of the main frame, suspended by a driving device via an elevator wire, and which are caused to be moved vertically in a state of contact with the masts; and, buffer member, which, among the pair of side frames connected to the main frame, is installed only between one of the side frames and the connection portion with the main frame.

By means of the invention having such a configuration, buffer member is installed between the main frame and a side frame comprised by the cage. Hence even in cases in which the side frames in contact with the masts are displaced due to distortion of the masts, at least a portion of the stress arising from this displacement is absorbed by the buffer member.

Further, in this invention, the buffer member can adopt a configuration comprising a long hole, formed in one among the main frame and the side frame, and a sliding pin, formed protruding from the other among the main frame and the side frame and mating with the long hole so as to enable movement along the direction of extension of the long hole.

Further, in this invention, a configuration can be adopted comprising impelling member which impels the sliding pin in the direction to move the side frame away from the main frame.

Further, in this invention, a configuration can be adopted in which the impelling member is a spring portion or a rubber portion.

By means of this invention, even when the side frames in contact with the masts are displaced due to distortion of the masts, at least a portion of the stress occurring due to the displacement is absorbed by the buffer member. Hence the transference to the main frame of the cage of at least a portion of the stress occurring due to the displacement can be prevented.

Hence by means of this invention, stress acting on the cage arising from a change in the mast interval can be reduced, without interposing a buffer member between the cage and guide rollers.

Further, buffer member capable of impelling by means of a spring or similar can be incorporated in the broad space of the connection portion between the cage main frame and a cage side frame, so that in cases in which large stresses act, a spring with a large spring constant can easily be employed.

Moreover, in cases of application in clean rooms there are concerns that dust may be generated; but because there are no masts or other structural members in the vicinity of the spring or other buffer member, a structurally simple cover can be installed. Hence installation and removal of the cover and similar can be performed easily, and maintenance tasks are facilitated. Moreover, the precision of transfer of goods is improved.

### BRIEF DESCRIPTION OF THE DRAWINGS

FIG. 1 is a plane view of an automated warehouse comprising the stacker crane of an aspect of the invention;

FIG. 2 is a side view of an automated warehouse comprising the stacker crane of an aspect of the invention;

FIG. 3 is a perspective view of the stacker crane of an aspect of the invention;

FIG. 4 is a front view of the stacker crane of an aspect of the invention;

FIG. 5 is a perspective view of the cage comprised by the stacker crane of an aspect of the invention;

FIG. 6 is a perspective view of a single side frame comprised by a cage;

FIG. 7 is an enlarged perspective view showing in enlargement the area of the end portion on one side of the main frame comprised by a cage; and,

FIG. 8 is an enlarged front view showing in enlargement the area of the end portion on one side of the main frame comprised by a cage.

### DESCRIPTION OF SYMBOLS

1 WHEEL
1a WHEEL
1b GUIDE ROLLER
2 MOTOR
10 LOWER FRAME
11 WHEEL MOUNTING PORTION
12 MAIN FRAME
13 SIDE FRAME
13a SIDE FRAME
13b SIDE FRAME MAST
20a MAST
20b MAST
30 UPPER FRAME
41 MAIN FRAME
42 REINFORCING MEMBER
43 SIDE FRAME
43a BOTTOM-EDGE PORTION
43b VERTEX PORTION
44 GUIDE PORTION
44a GUIDE PORTION
45 SUPPORT PORTION
46 GUIDE ROLLER
47 GUIDE ROLLER
47a GUIDE ROLLER
48 CONNECTION PORTION
49 PIN PORTION
50 DRIVING DEVICE
51 ELEVATOR WIRE
51a ELEVATOR WIRE
51b ELEVATOR WIRE
52 DRUM
53 MOTOR
54 DECELERATOR
55 SHEAVE
55a SHEAVE
55b SHEAVE
60 CONTROL DEVICE
61 CABLE
100 TRANSFER DEVICE
411 BEARING
411a BEARING
412 BEARING
413 LONG HOLE
414 SPRING PORTION
414a END
414b END PORTION
415 FIXED PLATE
431 SIDE FRAME
432 SIDE FRAME
C STACKER CRANE
CL1 CLEANROOM
R RAIL
R1 RAIL
R2 RAIL
R3 RAIL
S AUTOMATED WAREHOUSE
T Storage Shelf
T1 RACK
T2 RACK
X GOODS

### BEST MODE FOR CARRYING OUT THE INVENTION

Below, an embodiment of a stacker crane of this invention is explained, referring to the drawings. In the drawings below, the scale of various members is modified as appropriate in order that the various members be of a size enabling identification.

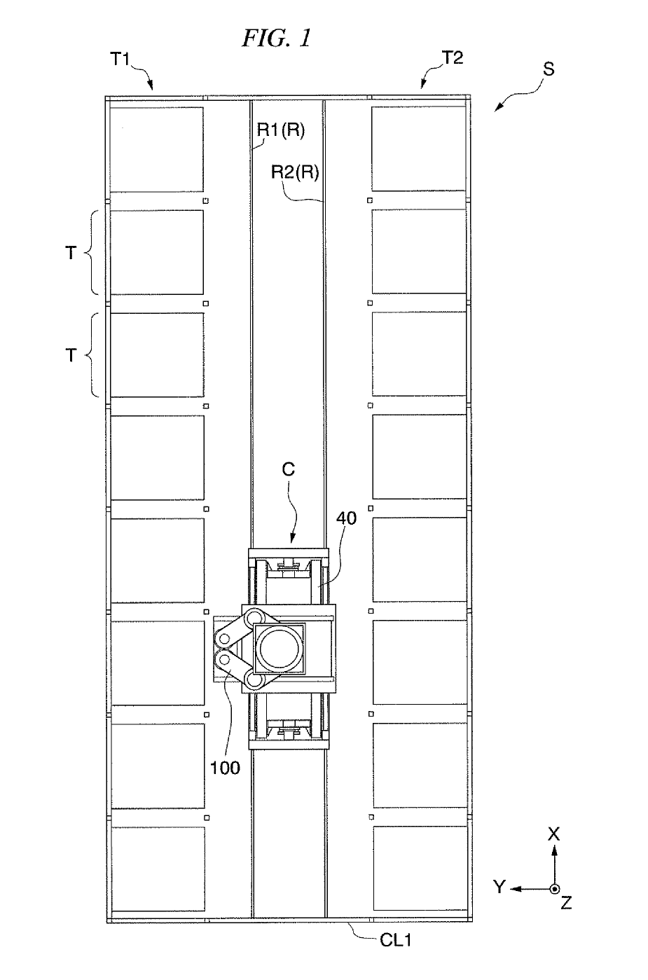

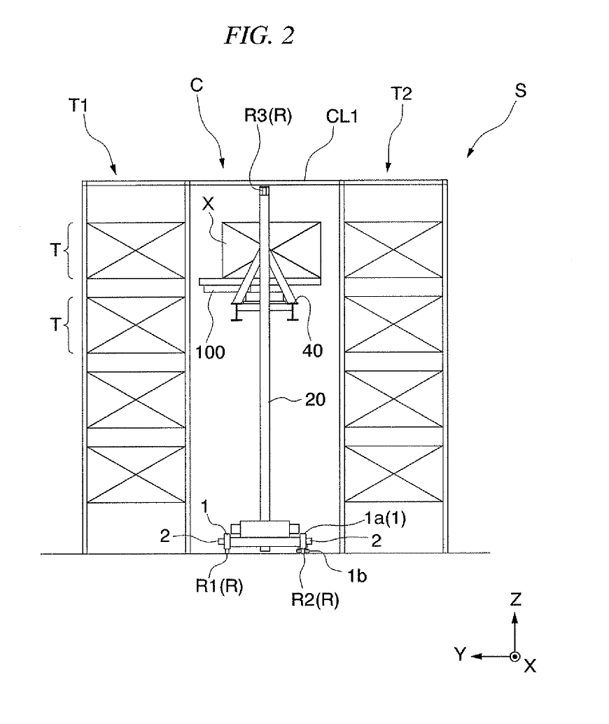

FIG. 1 is a plane view of an automated warehouse S comprising the stacker crane C of an embodiment of the invention. FIG. 2 is a side view of the automated warehouse S.

As shown in these figures, the automated warehouse S comprises the stacker crane C, and racks T1, T2 positioned in opposition on either side of rails R which are the track of the stacker crane C; goods are conveyed to and stored on the racks T1, T2 by the stacker crane C. The automated warehouse S further comprises a stocking conveyor (not shown) to stock goods, and a destocking conveyor (not shown) to destock goods; goods can be transferred between the stocking conveyor and the destocking conveyor by the stacker crane C.

In this embodiment, the goods are cassettes X in which a plurality of glass substrates are accommodated; the racks T1, T2 and stacker crane C are installed within a clean room CL1 with a cleanliness level of, for example, 10,000.

The racks T1, T2 comprise a plurality of storage shelves T arranged in the horizontal and vertical directions; cassettes X can be stored on each storage shelf T. That is, the racks T1, T2 comprise storage shelves T arranged on numerous levels. Further, the racks T1, T2 are configured with mutually opposing sides as the entries/exits for cassettes X.

In the following explanations, the horizontal arrangement direction of storage shelves T is the X direction, the horizontal direction perpendicular to the X direction is the Y direction, and the vertical direction perpendicular to the X-Y plane is the Z direction.

The rails R extend in the X direction, that is, are laid along the racks T1 and T2, and comprise rails R1 and R2 laid in parallel and at a prescribed interval on the floor of the clean room CL1, and a rail R3 laid on the ceiling of the clean room CL1.

The stacker crane C is supported from below by the rails R1 and R2, and comprises four wheels 1 which can rotate on the rails R1 and R2. Motors 2 are connected to each of the wheels 1, and the wheels 1 are driven in rotation by the motors 2 to cause the stacker crane C to travel on the rails R1, R2. Among the wheels 1, on the wheels 1a which rotate on the rail guide rollers 1b which are in contact with both side faces of the rail R2 are installed, and by means of the guide rollers 1b, the wheels 1a are guided on the rail R2.

The stacker crane C further comprises a cage 40 which moves vertically; by means of a transfer device 100 (for example, a forklift device) installed on the cage 40, cassettes X are passed between the cage 40 and storage shelves T, between the cage 40 and the stocking conveyor, and between the cage 40 and the destocking conveyor.

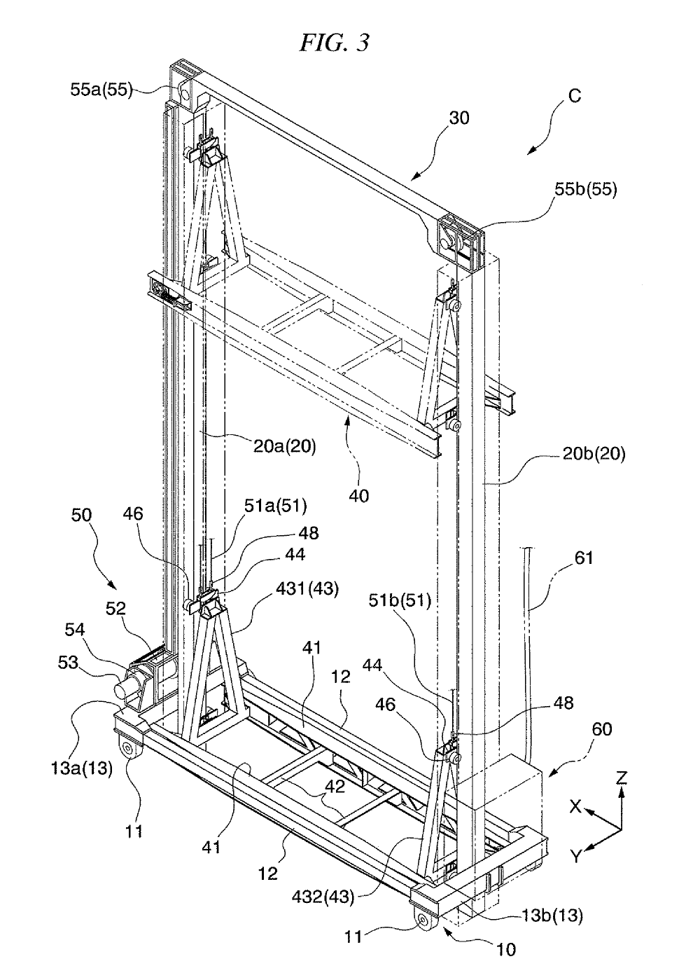

Next, details of the stacker crane C are explained, referring to FIG. 3 through FIG. 8.

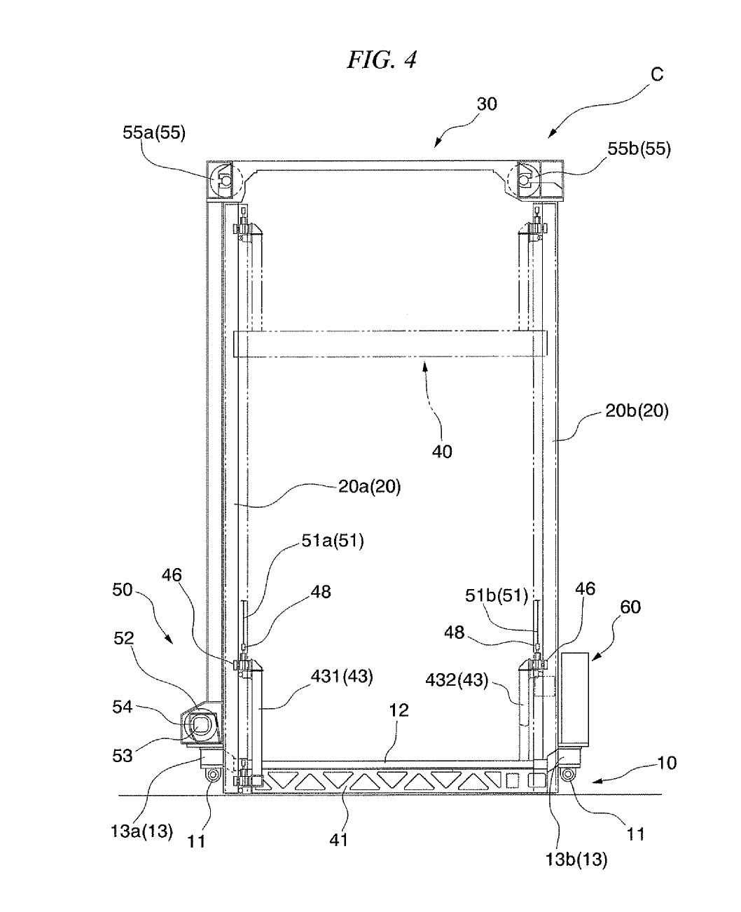

FIG. 3 is a perspective view of the stacker crane C. FIG. 4 is a front view of the stacker crane C. In FIG. 3 and FIG. 4, in order to improve the intelligibility of the drawings, the wheels 1, motors 2, guide rollers 1b, and transfer device 100 comprised by the stacker crane C are omitted.

As shown in these figures, the stacker crane C comprises a lower frame 10, masts 20, an upper frame 30, a cage 40, a driving device 50, and a control device 60.

The lower frame 10 is a foundation having wheel mounting portions 11 on which the above-described wheels 1 are rotatably installed, and comprises two main frames 12 extending in the X direction and arranged in parallel, and two side frames 13 which connect together the end portions of the two main frames.

The masts 20 are erected vertically on the lower frame 10, and comprise a mast 20a erected on one side frame 13a of the lower frame 10, and a mast 20b erected on the other side frame 13b of the lower frame. That is, the pair of masts 20a, 20b are installed on the lower frame 10 extending vertically in the Z direction. The masts 20a and 20b are arranged in the X direction. That is, the masts 20a and 20b are erected at the same Y-direction position.

The masts 20 have a square-column shape, and are erected such that each side face is parallel to the X direction or to the Y direction.

The upper frame 30 connects the upper-end portion of the mast 20a with the upper-end portion of the mast 20b, and is arranged extending in the X direction.

A guide roller (not shown) is installed in substantially the center portion of the upper frame 30, to deter Y-direction tilting motion of the stacker crane C by enclosing the rail R3.

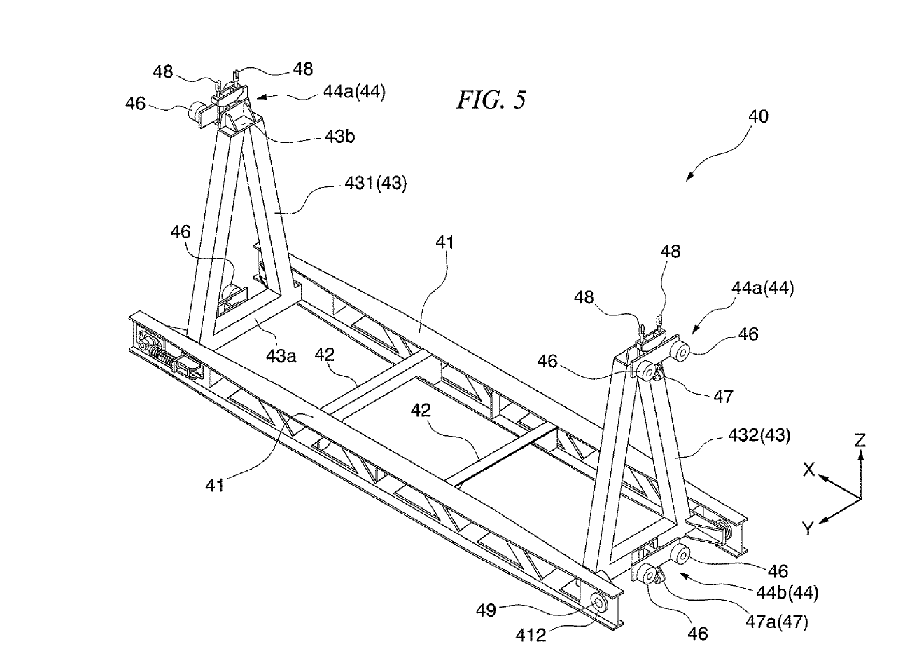

FIG. 5 is a perspective view of the cage 40. As shown in the figure, the cage 40 has two main frames 41 extending in the X direction. The main frames 41 are connected together by means of reinforcing members 42. Side frames 43 are connected to both end portions of the main frames 41.

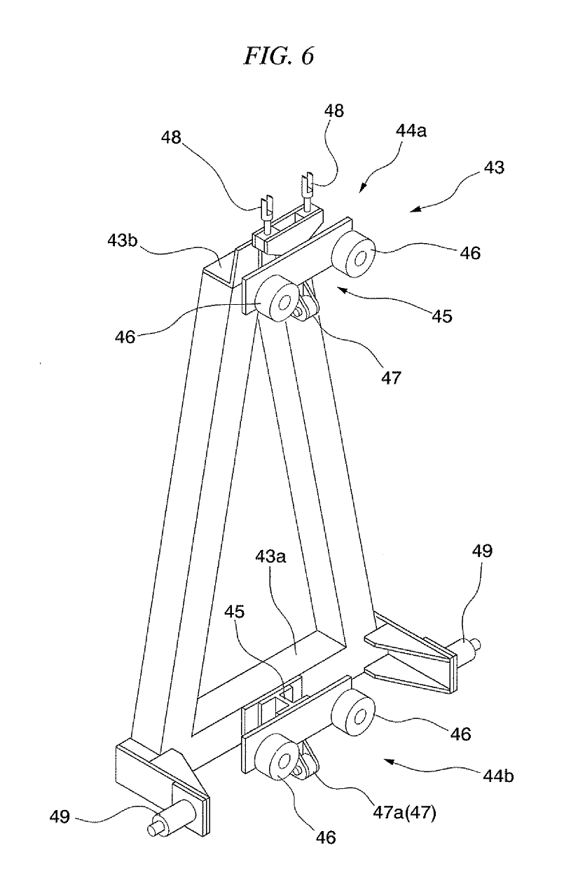

FIG. 6 is a perspective view of a single side frame 43. As shown in the figure, the side frames 43 are formed in substantially a triangular shape, with the connection portion 48, described below, at the vertex. And as shown in FIG. 5, the lower-edge portions 43a connect the two main frames 41. The side frames 43 comprise guide portions 44 protruding from the lower-edge portion 43a and the vertex portion 43b in the directions of the masts 20. The guide portions 44 are fixed to the side frame 43 by the support portions 45.

On the guide portions 44 are installed guide rollers 46 which enclose the masts 20, and small-size guide rollers 47, in contact with the side faces of the masts 20 parallel to the Y direction. The guide rollers 46 are in contact with the side faces of the masts 20 parallel to the X direction. The side faces of the masts 20 are used as sliding surfaces to the guide rollers 46, 47. That is, the side frame 43 moves vertically in a state of contact with the masts 20 with these guide rollers 46, 47 intervening. Through guidance by these guide rollers 46, 47, the side frames 43, and the cage 40, can move in the vertical direction (Z direction) along the masts 20.

Connection portions 48, to which are connected an elevator wire 51 comprised by the driving device 50, described below, are installed on the guide portions 44a protruding from the vertex portions 43b of the side frames 43.

As shown in FIG. 6, in the stacker crane C of this embodiment, pin portions 49 (sliding pins) are formed in both ends of the bottom-edge portion of the side frame 43, protruding in the Y direction.

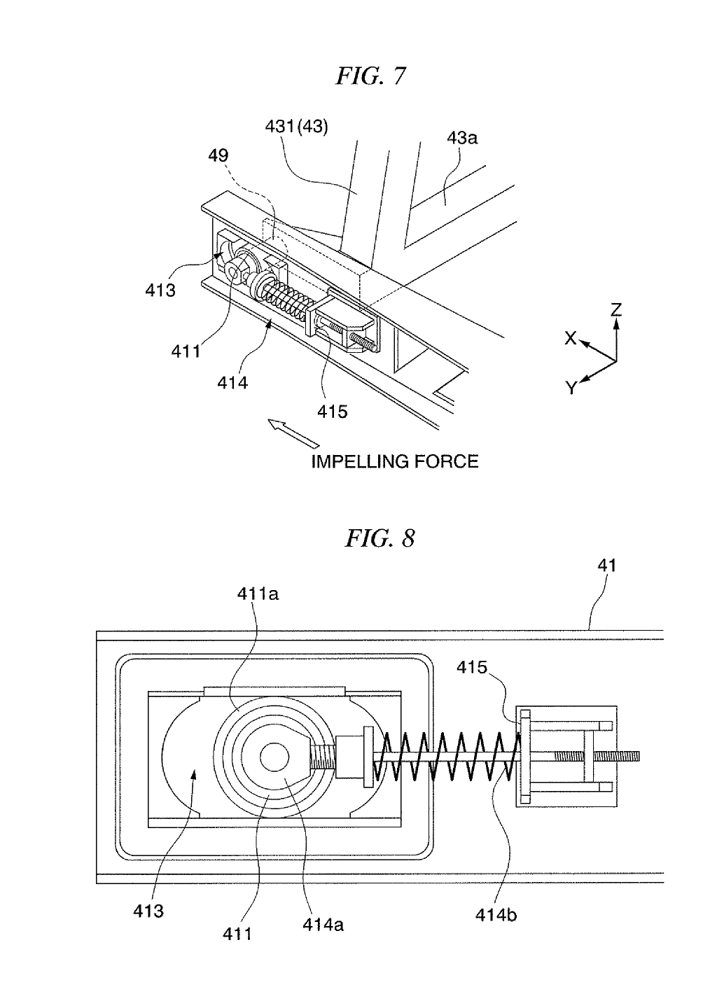

FIG. 7 is an enlarged perspective view showing in enlargement the area of the end portion of the main frame 41, on the side of the side frame 431. And, FIG. 8 is a front view showing in enlargement the area of the end portion of the main frame 41 on the side of the side frame 431. As is shown in these figures, a bearing 411 capable of pivotal support enabling rotation in the X-Y plane is installed in the neighborhood of the end portion of main frame 41 on the side of the side frame 431, such that the pin portion 49 formed in the side frame 431 is pivotally supported by the bearing 411. Further, a cover, not shown, is installed in the vicinity of the connection portion of the bearing 411 and the long hole 413, as necessary according to the cleanliness level and similar.

A long hole 413 extending in the X direction is formed in the area of the end portion of the main frame 41 on the side of the side frame 431, and the bearing 411 is mated with the long hole 413 to enable movement in the X direction. That is, the pin portion 49 is mated via the bearing 411 with the long hole 413, so as to enable movement in the direction of extension of the long hole 413. The periphery of the bearing 411 is molded with resin 411a, and by this means the bearing 411 can move smoothly in the long hole 413.

That is, in the stacker crane C of this embodiment, a pin portion 49 protruding from the side frame 431, and a long hole 413 formed in the main frame, are installed between the main frame 41 and the side frame 431.

Also, near the long hole 413 is installed a spring portion 414 (impelling member), one end 414a of which is connected to the pin portion 49 which extends penetrating the bearing 411. The end 414b of the spring portion 414 is fixed to a fixed plate 415 on the main frame 41. This spring portion 414 is installed so as to have an impelling force which impels the pin portion 49 of the side frame 431 in the direction of the mast 20a (in the direction moving the side frame 431 away from the main frame 41).

A pin portion 49, bearing 411, long hole 413, spring portion 414, and fixed plate 415 are also provided at connection sites of the main frame 41 and side frame 431 not shown in FIG. 7.

And, when the side frame 431 has moved in the direction away from the mast 20 (the −X direction) and when the main frame 41 has moved in the direction approaching the mast 20a (the +X direction), and power equal to or greater than the impelling force is applied to the spring portion 414, the bearing 411 moves within the long hole 413 in the direction relatively away from the mast 20a (the −X direction).

Returning to FIG. 5, a bearing 412 capable of pivotal support enabling rotation in the X-Z plane is installed in the neighborhood of the end portion of main frame 41 on the side of the side frame 432.

The bearing 412 does not have a spring portion 414 or long hole 413, as in the case of the bearing 411. Hence the side frame 432 which is the vicinity of the bearing 412 is impelled toward the mast 20b in the vicinity thereof by the impelling member (here called one system) in the side frame 431 which is the vicinity of the bearing 411, and the guide roller 47a on the side of the side frame 432 is always in a state of contact with the mast 20b. Hence there is the advantage that the transfer position of goods in the X-axis direction is constant with reference to the side of the mast 20b. That is, the precision of transfer of goods X onto storage shelves T is improved.

Here, if the above-described impelling member (spring portion 414) and buffer member (long hole 413 and other components) exist at each of the places in the side frame 431 and side frame 432 (that is, two systems), then due to the fact that either the sliding resistance of the contact portion of the bearing 411 of the impelling member on the side of the side frame 431 and the long hole 413 on the side of the side frame 431, or the sliding resistance of the contact portion of the bearing of the impelling member on the side of the side frame 432 and the long hole 413 on the side of the side frame 432, is larger, there is the possibility of variation in the X-axis direction position of the main frames 41 enclosed by the impelling member and buffer member of the series of two systems formed on the side of the side frame 431 and on the side of the side frame 432. Further, whether one system or two systems are present, if the external conditions are the same, then the reaction force of the guide rollers 47a on the masts 20 is the same, so that the spring constant of the series of two systems is the same, the movable range of the main frames 41 is twice as great insofar as there are two systems in series, and consequently the transfer position of goods in the X-axis direction is unstable.

In the stacker crane C of this embodiment, the impelling member and buffer member are installed only on one side, which is the side of the side frame 431, in order to eliminate the above cause of instability.

Returning to FIG. 3 and FIG. 4, the driving device 50 comprises elevator wires 51, a drum 52, motor 53, and decelerator 54.

One end of each elevator wire 51 is connected to the connection portion 48 of a guide portion 44 comprised by the side frames 43 of the cage 40, and the other end is wound around the drum 52. As the elevator wires 51, there exist an elevator wire 51a connected to the guide portion 44a of the side frame 431 positioned on the side of the mast 20a, and an elevator wire 51b connected to the guide portion 44a of the side frame 432 positioned on the side of the mast 20b; one end of both elevator wires 51a, 51b is wound around the drum 52.

Sheaves 55 to guide the elevator wires 51 are installed on the vertex portion of the mast 20a and on the vertex portion of the mast 20b. The sheave 55a installed on the vertex portion of the mast 20a is freely rotatable in the X-Z plane, and guides the elevator wire 51a to the guide portion 44a protruding from the side frame 431, as well as guiding the elevator wire 51b to the sheave 55b installed on the vertex portion of the mast 20b. The sheave 55b installed on the vertex portion of the mast 20b is freely rotatable in the X-Z plane, and guides the elevator wire 51b to the guide portion 44a protruding from the side frame 432.

The drum 52 is installed on the side frame 13a of the lower frame 10, and is capable of rotation about a rotation shaft oriented in the Y direction.

The motor 53 is connected to the drum 52 via the decelerator 54, and rotates the drum 52 via the decelerator 54. The motor 53 and decelerator 54 are each installed at both ends of the drum 52.

The control device 60 controls operation of the entire stacker crane C, and is installed on the side frame 13b of the lower frame 10. The control device 60 is electrically connected by a cable 61 to an external control device which controls the entire automated warehouse S.

In such a stacker crane C, by controlling the motor 53 to adjust the amount of rotation of the drum 52, the winding amounts of the elevator wires 51 are changed, and by this means the height of the side frames 43 of the cage 40 connected to the elevator wires 51 is adjusted. That is, the height of the cage 40 is controlled by driving of the driving device 50.

When, due to bowing of the center portions of the masts 20 toward the cage 40 as a result of the weight of the cage 40 and the driving force of the driving device 50, transmitted via the elevator wires 51, the mast interval changes along the vertical direction, in the process of vertical movement of the cage 40 along the masts 20, horizontal stresses (stress) act on the cage 40.

On the other hand, in the stacker crane C of this embodiment the horizontal stress can be absorbed by movement of the bearings 411 in the long holes 413, that is, by movement of the pin portions 49 in the long holes 413. That is, in this embodiment, the pin portions 49 and long holes 413 function as the buffer member of this invention.

Hence even when the center portions of the masts 20 are bowed on the side of the cage 40, strong horizontal stresses do not act on the side frames 43 or main frames 41, and there is no need to form the side frames 43 and main frames 41 thick so as to withstand such horizontal stresses.

By means of the stacker crane C of this embodiment, even when the side frames 431 in contact with the masts 20 are displaced due to distortion of the masts 20, at least a portion of the horizontal stress arising from this displacement is absorbed by the pin portions 49 and long holes 413 installed between the side frame 431 and the main frames 41. Hence transmission of at least a portion of the horizontal stress arising due to the displacement to the main frames 41 of the cage 40 can be reduced.

As a result, by means of the stacker crane C of this aspect, horizontal stress acting on the cage 40 due to changes in the interval between the masts 20a and 20b can be reduced, without interposing buffer members between the cage 40 and the guide rollers 46, 47.

Further, by means of the stacker crane C of this embodiment, spring portions 414 having an impelling force so as to impel the pin portions 49 of the side frame 431 in the direction of the mast 20a (impelling the side frame 431 in the direction away from the main frame 41) are comprised. Hence when the mast interval is the normal interval, the pin portions 49 are returned to their prescribed positions by the impelling force of the spring portions 414, so that the normal state of the shape of the cage 40 can be retained.

In the above, a preferred embodiment of a stacker crane of this invention has been described, referring to the drawings; of course the invention is not limited to this embodiment. The shapes and combinations of constituent members described in the above embodiment are merely examples, and various modifications can be made, based on design requirements, without deviating from the gist of the invention.

For example, in the above embodiment, a configuration was explained in which the pin portions 49 are fixed to the side frames 43, and the bearings 411, 412 are installed on the main frames 41. However, this invention is not limited to such a configuration, and the opposite configuration, in which the bearings are installed on the side frames and the pin portions are fixed to the main frames, can be adopted as well.

Further, in the above embodiment, an explanation was given in which the buffer member of this invention comprise pin portions 49 and long holes 413. However, this invention is not limited to such a configuration, and for example buffer member may employ rubber portions, spring portions, or other mechanisms.

Further, in the above embodiment, an explanation was given in which the impelling member of this invention comprise spring portions 414. However, this invention is not limited to such a configuration, and for example impelling member may employ rubber portions.

Further, in the above embodiment, pin portions 49, bearings 411, long holes 413, spring portions 414, and fixed plates 415 may be installed at the connection sites of the main frames 41 and side frame 432 as well. In this case, the bearings 412 are not installed.

### INDUSTRIAL APPLICABILITY

By means of this invention, even when a side frame in contact with a mast is displaced due to distortion of the mast, at least a portion of the stress occurring due to the displacement is absorbed by buffer member. For this reason, transmission to the main frames of the cage of at least a portion of the stress occurring due to the displacement can be reduced.

Hence by means of this invention, stress acting on the cage arising from a change in the mast interval can be reduced, without interposing a buffer member between the cage and guide rollers.

Further, buffer member capable of impelling by means of a spring or similar can be incorporated in the broad space of the connection portion between the cage main frames and a cage side frame, so that in cases in which large stresses act, a springs with a large spring constant can easily be employed.

Moreover, in cases of application in clean rooms there are concerns that dust may be generated; but because there are no masts or other structural members in the vicinity of the spring or other buffer means, a structurally simple cover can be installed. Hence installation and removal of the cover and similar can be performed easily, and maintenance tasks are facilitated. Moreover, the precision of transfer of goods is improved.

1. A stacker crane, which travels on a track provided along storage shelves arranged on numerous levels, and which, by causing a cage which receives goods to move vertically between a set of masts erected vertically, conveys goods between storage shelves, wherein said cage comprises:
a main frame, on which said goods are placed;
a pair of side frames, provided at each of the end portions of the main frame, suspended by a driving device via an elevator wire, and which are caused to be moved vertically in a state of contact with said masts; and,
buffer member, which, among the pair of side frames connected to said main frame, is installed only between one of the side frames and the connection portion with said main frame.

2. The stacker crane according to claim 1, wherein said buffer member comprises a long hole, formed in one among said main frame and said side frame, and a sliding pin, formed protruding from the other among said main frame and said side frame and mating with said long hole so as to enable movement along the direction of extension of said long hole.

3. The stacker crane according to claim 1, comprising impelling member which impels said sliding pin in the direction moving said side frame away from said main frame.

4. The stacker crane according to claim 3, wherein said impelling member is a spring portion or a rubber portion.

5. The stacker crane according to claim 1, comprising a cover which prevents generation of dust from said buffer member or from said impelling member.
